(19) United States
(12) Patent Application Publication
(10) Pub. No.: US 2016/0302550 A1
(43) Pub. Date: Oct. 20, 2016

(54) Method of Making and Delivering Custom Fit Gem Set False Nails

(71) Applicant: DANA CODY TEICHNER, South Beach, FL (US)

(72) Inventor: DANA CODY TEICHNER, South Beach, FL (US)

(21) Appl. No.: 14/691,165

(22) Filed: Apr. 20, 2015

(51) Int. Cl. A45D 31/00; G06Q 30/06; G06Q 40/08; A44C 17/02; A44C 17/04

(52) U.S. Cl. CPC A45D 31/00; A44C 17/02; A44C 17/04; G06Q 40/08; G06Q 30/0621

(57) ABSTRACT

A method of making and delivering custom fit gem set false nails that enables an end user to order and receive custom fit false nails that match the dimensions of real nails, and have a unique design including gems and precious metals. The end user initially views and selects from different gems, precious metals, and colors and patterns that can be integrated into false nails. The real nails of the end user are replicated through a kit that is delivered to the end user. The kit includes a modeling agent, such that the end user can self-form a negative impression cast of the real nails. A mold of the false nails is created that matches the negative false impression. The false nails with the selected design are delivered to the end user for application on the real nails. The false nails may be insured for delivery or while adorned.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to a method of making and delivering custom fit gem set false nails.

It is known that false fingernails are coverings placed over fingernails as fashion accessories. False fingernails typically comprise thin, elongated, plastic structures having a configuration substantially similar to a real fingernail. Some artificial nails attempt to replicate the appearance of real fingernails as closely as possible, while other designs may deliberately stray in appearance from real fingernails. Yet other false fingernails are more extravagant and showy.

The inventor had many years of experience both wearing and applying false fingernails. The inventor was aware that through use of an adhesive, the false fingernails could selectively secure to existing real fingernails. The inventor was also aware that one of the benefits of false fingernails is that they enable a user to have uniform fingernails of a desired thickness, length, and configuration without having to wait for the real fingernails to grow. This was especially useful for weak fingernails that easily crack or break. Another realized benefit was the myriad decorative possibilities that could be used with false fingernails.

The inventor knew that many users of false fingernails preferred a more decorative enhancement to the natural colored false fingernail. The inventor noticed that these users generally applied nail polish, decals or other decorations to false fingernails after they were secured over real fingernails. Unfortunately, once the false fingernails were secured in place, applying nail polish or other decorations was often messy and time-consuming.

The inventor also observed problems in that nail polish was often spilled or painted onto fingers; applying polish to fingernails on the dominant hand required use of the non-dominant hand; and time is required to both apply nail polish and to allow the polish to dry.

Furthermore, the inventor realized that many users wanted extremely extravagant designs on the false fingernails to portray a status symbol. These users would often paint multi-color designs on each nail, sometimes adding sparkles, decals, and other design elements to enhance the overall appearance of the polished nails. This was usually done by airbrushing or free hand painting, both of which require a considerable degree of skill and artistic ability.

The inventor also recognized that users often went to a nail salon to find qualified nail specialists. This was often problematic. The driving, expense, and long waiting times were not always feasible in a fast paced, time starved society. The inventor wondered if it would be possible to remotely supply high end false fingernails to the higher end users of false fingernails.

The inventor understood that it was possible to reach the most potential users through the Internet. The inventor designed a website for displaying, selling, and distributing false fingernail with decorative appeal. The inventor displayed a variety of different predesigned false fingernails. Through the inventor's website, a user could select the desired design, and it would be mailed through normal shipping practices. The false fingernails were generally decorative and creative. The inventor also realized that a store front and a catalog could be used to display and sell the false fingernails.

However, the inventor recognized that the users wanted even more elaborate designs tan merely decorative colors and patterns. The inventor researched jewelry design methods, and concluded that a precious metal, such as gold or platinum, could overlay the false fingernail. After studying various epoxies, gels, and glues used in the fingernail industry, the inventor also concluded that a gem, such as a diamond, could be set into the false fingernail. The inventor finally decided to allow the users to select from any combination of gems, precious metals, and colors from the website.

However, the users were not sufficiently pleased with the final product. The cuticles of the false fingernails were often too large or too tight. Obtaining accurate measurements of the real nail was problematic. The inventor decided to send a kit with a modeling agent included every time a user placed an order. The order would not be filled until the user made a negative impression cast from the modeling agent in the kit, and resubmitted back. In this manner, the inventor realized that a more precise fit for the false fingernail could be achieved.

However, after a few lost orders and possible fraud, the inventor understood that the high value of the gems and precious metals would require insurance. Thus, the inventor provided insuring means to the users. The false fingernails could thus be insured during shipping and while being adorned by the user.

For the foregoing reasons, there is a method of making and delivering custom fit gem set false nails.

Designer false fingernails have been utilized in the past; yet none with the present gem and precious metal containing means of the present invention. See U.S. Pat. Nos. 3,157,912; 6,367,484; and 20070057143.

For the foregoing reasons, there is method of making and delivering custom fit gem set false nails. The method enables an end user to order and receive custom fit false nails that match the real nails of the end user, and that have a unique design selected by the end user.

### SUMMARY

The present invention describes a method of making and delivering custom fit gem set false nails. The method provides an efficient, automated mechanism that delivers custom fit false nails tailored by an end user to match the dimensions of a real nail, while also integrating a selected gem and precious metal into the false nail. The false nails are unique in that they are set with a gem selected by the end user. The false nails are also overlaid with a precious metal, and may also have a distinct color and pattern selected by the end user. In each case, the end user selects the desired unique design for the false nails from myriad combinations of gems, precious metals, and colors and patterns.

The end user may view and select at least one unique design for the false nail from a website. However, the end user may also view and select the unique design from an infomercial, a catalog, an order form, a telemarketer, and a salesperson. In one alternative embodiment, the end user may build a unique design by interchanging different combinations of gems, precious metals, and colors and patterns.

In some embodiments, the real nails of the end user are replicated to provide the optimal fit. For this means, a kit containing a modeling agent is delivered to the end user. The kit includes instructions that enable the end user to form a negative impression cast of the real nails, including the fingers and thumbs. After forming the negative impression cast, the end user returns the negative impression cast for molding of false nails. The mold is cut to substantially match the real nails of the end user. Thus, by using the negative impression cast, a mold of a false nail is cut, based on the dimensions of the real nail.

In some embodiments, a precious metal is then overlaid over the false nail. This may be performed by a goldsmith. The gem is then set into the false nail, following the unique design selected by the end user. In one embodiment, a diamond setter may set at least one diamond accordingly. Various epoxies, acrylic beads, clear gels, and ultra violet curing means known in the art may be used to set the gems. Additionally, a color and pattern may be applied to the false nail to highlight the gems and precious metals. It is significant to note that the order of application of the gem, precious metal, and color and pattern is interchangeable, depending on the technical requirements for the unique design.

In some embodiments, the method further includes delivering the false nail with the unique design to the end user. The false nail may be delivered by mail. Those skilled in the art, in light of the present teachings, will recognize that the value of the false nail, especially being set with gems and overlain with a precious metal is monetarily high, and thus may require insuring. Upon receiving the false nail, the user is instructed on applying the false nails. Generally, this is accomplished by gluing the false nail over the real nail, and applying acrylic over the false nail. Though, in some embodiments, a nail salon may be employed for applying the false nails to the real nails of the end user.

In one alternative embodiment, the end user may form a second negative impression cast with the modeling agent in the kit. The the second negative impression cast may then be returned to create a second mold for a second false nail. The end user may then select a second unique design. This pattern may be repeated, such that multiple false nails set with gems and overlaid with precious metals may be interchangeably adorned by the end user.

One objective of the present invention is to provide a unique design for false nails that includes a gem, an overlaid precious metal, and a color and pattern.

Yet another objective of the present invention is to provide a status symbol on the real nails with the gem and precious metals.

Another objective of the present invention is to provide a nonpermanent, interchangeable false nail.

Yet another objective is to provide a hygienic false nail and application of false nail on a real nail by customizing the casting and design of the false nail.

Another objective is to enable an end user to view myriad combinations of gems, precious metals, and colors and patterns on a website.

Yet another objective of the present invention is to provide a variety of gems and precious metals, and combinations thereof for the false nails.

Another objective of the present invention is to deliver a kit that includes a modeling agent to the end user, such that the end user can easily produce a negative impression cast of the real nails on the fingers and thumbs.

Another objective of the present invention is to cut molds of false nails that have substantially the same size and dimensions of the real nails based on the negative impression cast.

Yet another objective is to provide insurance for protecting the false nails from theft or damage during delivery, or while being adorned by the end user.

Another objective of the present invention is to enable the end user to make multiple negative impression casts from the sane modeling agent.

Yet another objective is to provide an inexpensive means for ordering false nails with unique designs, including gems, precious metals, and colors and patterns.

### DRAWINGS

These and other features, aspects, and advantages of the present invention will become better understood with regard to the following description, appended claims, and drawings where:

FIG. 1 is a perspective view of an exemplary false nail having a gem and a precious metal being applied to an exemplary real nail;

FIG. 2 is a block diagram of an exemplary system of making and delivering custom fit gem set false nails;

FIGS. 3A and 3B are flowchart diagrams of an exemplary method of making and delivering custom fit gem set false nails; and

FIG. 4 is a block diagram depicting an exemplary client/server system which may be used by an exemplary web-enabled/network for operating the method of making and delivering custom fit gem set false nails.

### DESCRIPTION

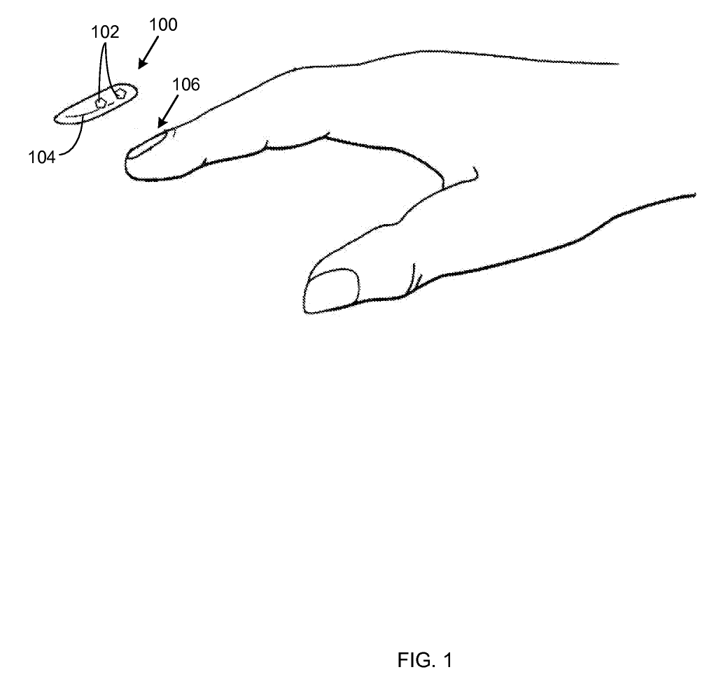

The present invention, referenced in flowchart diagrams FIGS. 1-4, is directed to an exemplary method 200 of making and delivering custom fit gem set false nails. As illustrated in FIG. 1, the method 200 enables an end user 120 to order and receive custom fit false nails 100 that match the dimensions of the end user's 120 real nails 106, and that have a unique design selected by the end user 120. The false nails 100 are especially unique in that the unique design includes a gem 102 that is set into the false nail 100, a precious metal 104 that overlays the false nail 100, and a unique color and pattern that compliments the gem 102.

The gem 102 may include, without limitation, a diamond, a ruby, an emerald, a pearl, a sapphire, an amethyst, a crystal, and a rhinestone. The precious metal 104 may include, without limitation, gold, platinum, and silver. Additional colors and patterns may also be selected by the end user 120 to compliment the gem 102 and the precious metal 104. In each case, the end user 120 selects the desired unique design for the false nail 100 from myriad combinations of gems 102, precious metals 104, and colors and patterns.

The method 200 provides numerous advantages. For example, the custom designed false nail 100 creates a status symbol through integrated the gem 102 and precious metal 104. The method 200 also provide a nonpermanent, interchangeable false nail 100 that can be adorned as needed. Yet another advantage of the method 200 is that the false nail 100 and application thereof is hygienic. Yet another advantage is the easy to shop and access remote viewing and purchasing features of the method 200.

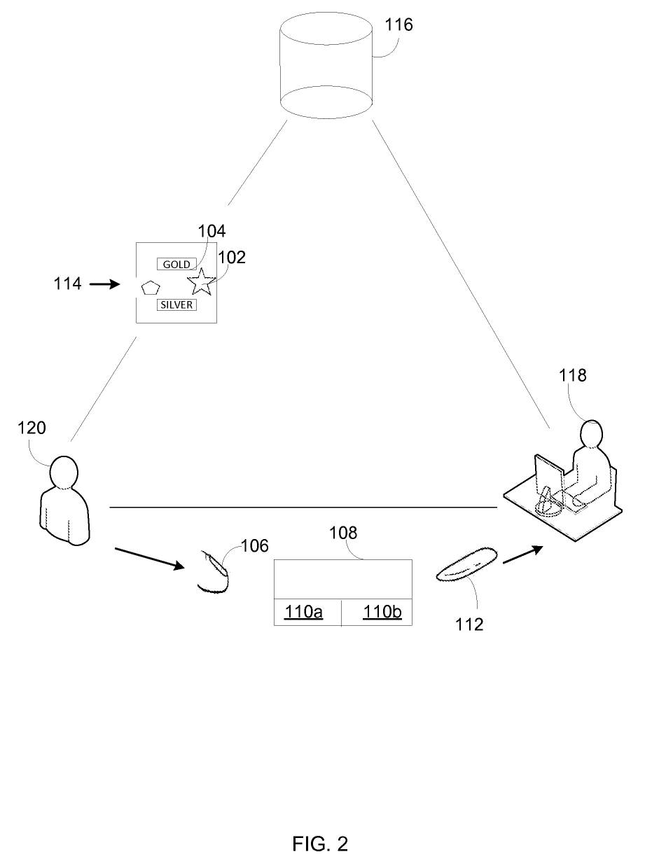

Turning now to FIG. 2, the end user 120 may initially view and select from different gems 102, precious metals 104, and colors and patterns that can be integrated into the false nails 100. An organization 118, such as a nail supply company, may display the selections available for distribution and sale. The dimensions of the real nails 106 are replicated with the help of a kit 108 that the organization 118 delivers to the end user 120. The kit 108 includes instructions, a spatula, and easy to mix modeling agent enables the end user 120 to self-form a negative impression cast 112 of the real nails 106. The end user 120 returns the negative impression cast 112 to the organization 118 for further processing. A mold of the false nails 100 is then created that matches the negative impression cast 112. The false nails 100, having the end user's 120 selected unique design and precise dimensions of the real nails 106, are then delivered to the end user 120 for application onto the real nails 106. Additionally, the false nails 100 may be insured during delivery, or while adorned.

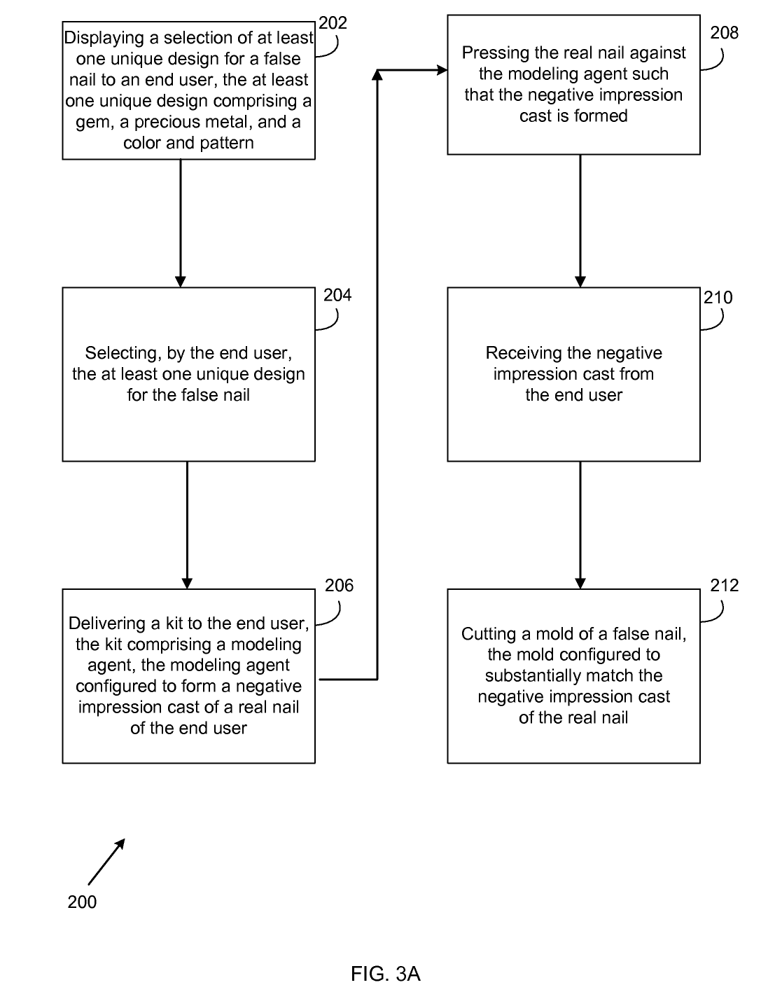

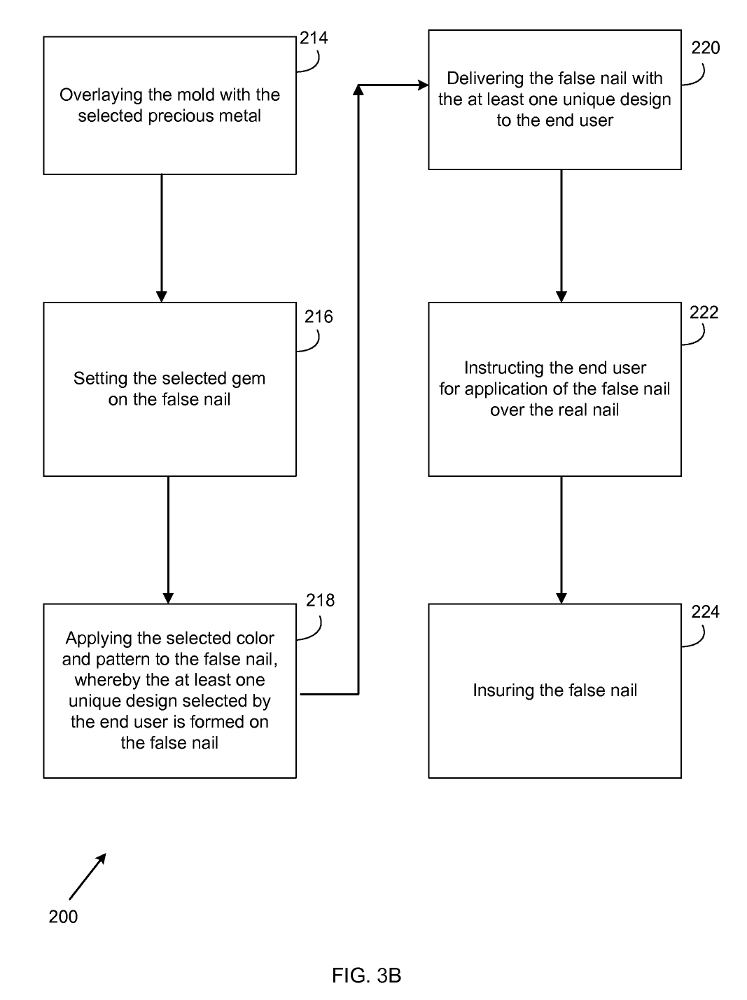

As illustrated in flowchart diagrams FIGS. 3A and 3B, the method 200 may include an initial Step 202 of displaying a selection of at least one unique design for a false nail 100 to an end user 120, the at least one unique design comprising a gem 102, a precious metal 104, and a color and pattern. In one possible embodiment, the selection of gems 102, precious metals 104, and colors and patterns may be displayed, sold, and distributed on a commercial web site. However, in other embodiments, the selection may be accessible from a catalog, a brochure, an infomercial, or presented verbally by a telemarketer or salesperson. The end user 120 can view the selection on a display 114, such as a computer screen, television screen, or smartphone display.

Looking back to FIG. 2, the method 200 may also include a database 116 for storing images, prices, delivery means, and general information about the gem 102, a precious metal 104, and a color and pattern. Information for physically applying the false nail 100 to the real nail 106 can also be stored on the database 116 for access by both the end user 120 and the organization 118. Standard networks, Internets, and software applications known in the art may be used to store, transmit, and display the selection of gems 102, precious metals 104, and colors and patterns.

The method 200 may further comprise a Step 204 of selecting, by the end user 120, the at least one unique design for the false nail 100. The end user 120 may visit the selection by surfing the Internet. The end user 120 may click to select any combination of gems 102, precious metals 104, or colors and patterns for application on the false nails 100. In one possible embodiment, the end user 120 may build a unique design for the desire false nail 100 by interchanging different combinations of gems 102, precious metals 104, and colors and patterns. However, in other embodiments, the end user 120 selects from preconfigured designs. In one alternative embodiment, a model nail appears on the display 114. As the end user 120 selects a gem 102 or precious metal 104, the same appears on the model nail. In this manner, a more accurate visualization of the final product false nail 100 is viewable to the end user 120 before making the final order.

A Step 206 includes delivering a kit 108 to the end user 120, the kit 108 comprising a modeling agent, the modeling agent configured to form a negative impression cast 112 of a real nail 106 of the end user 120. The kit 108 may include a simple container that is lightweight and relatively easy to deliver by mail. In one embodiment, the kit 108 comprises a plastic container having a lid and at least one compartment 110a, 110b that is configured to hold a modeling agent and receive the digits, i.e., fingers and thumbs, of the end user 120. The modeling agent may include a pre-mix mixture. The modeling agent may include any cast known in the art that forms a negative impression cast 112. A spatula is also provided in the kit 108 for mixing and handling of the modeling agent, per instructions, to achieve a desired consistency for modeling of the real nail 106. In another embodiment, two compartments in the kit 108 receive four fingers from each hand, and two additional compartment receive each thumb. In this manner, the real nails 106 can be most efficiently cast into an accurate negative impression cast 112.

In some embodiments, a Step 208 comprises pressing the real nail 106 against the modeling agent such that the negative impression cast 112 is formed. In one possible means for modeling the real nails 106, the cuticles of the real nail 106 are trimmed and cleaned. The real nail 106 is then pressed against the surface of the respective compartment 110a, 110b until the modeling agent hardens and has the identical configuration of the top surface of the real nail 106. Alternatively, the real nail 106 can be sculpted out of a modeling agent such as wax or other materials. In any case, the real nails 106 are replicated through the modeling agent to form the negative impression cast 112.

A Step 210 includes receiving the negative impression cast 112 from the end user 120. The end user 120 may mail the negative impression cast 112 to be replicated into false nails 100. During shipping, the negative impression cast 112 can be protected against damage by wrapping in bubble wrap or foam. In some embodiments, a Step 212 may include cutting a mold of a false nail 100, the mold configured to substantially match the negative impression cast 112 of the real nail 106. The cut mold, in essence, forms the false nail 100. The mold is cut to substantially match the real nails 106 of the end user 120. Thus, by using the negative impression cast 112, a mold of a false nail 100 is cut, based on the dimensions of the real nail 106. In one possible embodiment, the mold of the false nail 100 is a lightweight plastic configured to seamlessly overlay the real nail 106.

A Step 214 comprises overlaying the mold of the false nail with the selected precious metal 104. A goldsmith or jeweler may perform this Step 214. A Step 216 may include setting the selected gem 102 on the false nail 100. A diamond setter or jeweler may perform this Step 216. Various epoxies, acrylic beads, clear gels, and ultra violet curing means known in the art may be used to set the gems 102. Additionally, a color and pattern may be applied to the false nail 100 to highlight the gems 102 and precious metals 104.

A Step 218 includes applying the selected color and pattern to the false nail 100, whereby the at least one unique design selected by the end user 120 is formed on the false nail 100. It is significant to note that the order of application of the gem 102, precious metal 104, and color and pattern is interchangeable, depending on the technical requirements for the unique design. In some embodiments, a Step 220 may include delivering the false nail 100 with the at least one unique design to the end user 120. The false nail 100 may be delivered by mail, courier, or the end user 120 may pick up the false nails 100.

A Step 222 comprises instructing the end user 120 for application of the false nail 100 over the real nail 106. Upon receiving the false nail 100, the user is instructed on applying the false nails 100 (FIG. 1). Generally, this is accomplished by gluing the false nail 100 over the real nail 106, and applying acrylic over the false nail 100. Though, in some embodiments, a nail salon may be employed for applying the false nails 100 to the real nails 106 of the end user 120.

An additional Step 224 includes insuring the false nail 100. Those skilled in the art, in light of the present teachings, will recognize that the value of the false nail 100, especially being set with gems 102 and overlain with a precious metal 104 is monetarily high, and thus may require insuring. Standard insuring means, known in the art, may be applied in Step 224.

In one alternative embodiment, an additional step may include forming a second negative impression cast 112 with the modeling agent, the second negative impression cast 112 used to create a second mold of a second false nail 100. The end user 120 forms a second negative impression cast 112 with the modeling agent in the kit 108. The second negative impression cast 112 may then be returned to create a second mold for a second false nail 100. This step can be repeated until the physical constitution of the modeling agent is depleted for purposes of forming negative impression casts 112. Yet another alternative step may include selecting a second unique design for the second false nail 100.

Thus, the end user 120 can repetitively create new designs for subsequent false nails 100 through use of the same kit 108. Finally, the end user 120 can make payment for the false nail 100 before, during, or after formation of the final product. Standard means of payment known in the art can be used, including, cash, check, money order, credit card, bank transfers. In one possible embodiment, the end user 120 makes payment after the Step 204 of selecting the at least one unique design for the false nail 100.

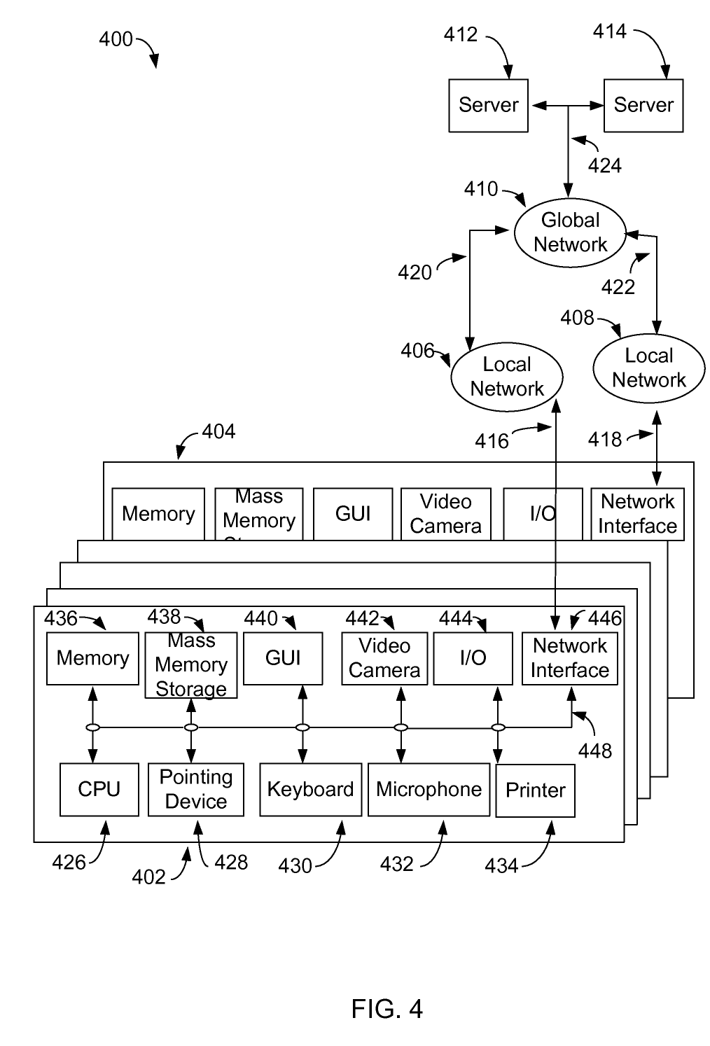

FIG. 4 is a block diagram depicting an exemplary client/server system which may be used by an exemplary web-enabled/networked embodiment of the present invention.

A communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the end user may repetitively use the same kit to produce multiple negative impression casts for different false nails with different unique designs. Accordingly, the scope should be determined not by the embodiments illustrated, but by the appended claims and their legal equivalents.

What is claimed is:

1. A method of making and delivering custom fit diamond set false nails, the method comprising:
displaying a selection of at least one unique design for a false nail to an end user, the at least one unique design comprising a diamond, a precious metal, and a color and pattern;
selecting, by the end user, the at least one unique design for the false nail;
delivering a kit to the end user, the kit comprising a modeling agent, the modeling agent configured to form a negative impression cast of a real nail of the end user;
pressing the real nail against the modeling agent such that the negative impression cast is formed;
receiving the negative impression cast from the end user;
cutting a mold of a false nail, the mold configured to substantially match the negative impression cast of the real nail;
overlaying the mold with the selected precious metal;
setting the selected diamond on the false nail;
applying the selected color and pattern to the false nail, whereby the at least one unique design selected by the end user is formed on the false nail;
delivering the false nail with the at least one unique design to the end user; and
instructing the end user for application of the false nail over the real nail.

2. The method of claim 1, further including the step of insuring the false nail.

3. The method of claim 1, further including the step of forming a second mold with the modeling agent, the second mold used to create a second false nail.

4. The method of claim 1, wherein the step of displaying a selection of at least one unique design for a false nail to an end user, further comprises displaying the selection of the at least one unique design on a website.

5. The method of claim 1, wherein the step of selecting, by the end user, the at least one unique design for the false nail, further includes selecting the at least one unique design through a computer.

6. The method of claim 1, wherein the precious metal includes at least one member selected from the group consisting of: gold, platinum, and silver.

7. The method of claim 1, wherein the kit is a food saver kit.

8. The method of claim 1, wherein the kit is defined by a plastic container having a lid and at least one compartment.

9. The method of claim 8, wherein the at least one compartment is configured to hold the modeling agent and receive the fingers and thumbs of the end user.

10. The method of claim 9, wherein the at least one compartment has two compartments for each of the four fingers, and two compartments for each thumb.

11. The method of claim 1, wherein the modeling agent is a pre-mix mixture.

12. The method of claim 11, wherein the kit has a spatula for mixing the pre-mix mixture.

13. The method of claim 1, wherein the step of overlaying the mold with the selected precious metal is performed by a goldsmith.

14. The method of claim 1, wherein the step of setting the selected diamond on the false nail is performed by a diamond setter.

15. The method of claim 1, wherein the step of instructing the end user for application of the false nail over the real nail, further comprises gluing the false nail over the real nail, and applying acrylic over the false nail.

16. A method of making and delivering custom fit gem set false nails, the method comprising:
displaying a selection of at least one unique design for a false nail to an end user, the at least one unique design comprising a gem, a precious metal, and a color and pattern;
selecting, by the end user, the at least one unique design for the false nail;
delivering a kit to the end user, the kit comprising a modeling agent, the modeling agent configured to form a negative impression cast of a real nail of the end user;
pressing the real nail against the modeling agent such that the negative impression cast is formed;
receiving the negative impression cast from the end user;
cutting a mold of a false nail, the mold configured to substantially match the negative impression cast of the real nail;
overlaying the mold with the selected precious metal;
setting the selected gem on the false nail;
applying the selected color and pattern to the false nail, whereby the at least one unique design selected by the end user is formed on the false nail;
delivering the false nail with the at least one unique design to the end user;
instructing the end user for application of the false nail over the real nail; and
insuring the false nail.

17. The method of claim 1, wherein the step of displaying a selection of at least one unique design for a false nail to an end user, further comprises displaying the selection of the at least one unique design on a website.

18. The method of claim 1, wherein the kit is defined by a plastic container having a lid and at least one compartment, the at least one compartment configured to hold the modeling agent and receive the fingers and thumbs of the end user.

19. The method of claim 1, wherein the gem includes at least one member selected from the group consisting of: a diamond, a ruby, an emerald, a pearl, a sapphire, an amethyst, a crystal, and a rhinestone.

20. A method of making and delivering custom fit diamond set false nails, the method comprising:
displaying a selection of at least one unique design for a false nail to an end user, the at least one unique design comprising a gem, a precious metal, and a color and pattern;
selecting, by the end user, the at least one unique design for the false nail;
delivering a kit to the end user, the kit comprising a modeling agent, the modeling agent configured to form a negative impression cast of a real nail of the end user;
pressing the real nail against the modeling agent such that the negative impression cast is formed;
receiving the negative impression cast from the end user;
cutting a mold of a false nail, the mold configured to substantially match the negative impression cast of the real nail;
overlaying the mold with the selected precious metal;
setting the selected diamond on the false nail;
applying the selected color and pattern to the false nail, whereby the at least one unique design selected by the end user is formed on the false nail;
delivering the false nail with the at least one unique design to the end user;
instructing the end user for application of the false nail over the real nail;
insuring the false nail;
forming a second negative impression cast with the modeling agent, the second negative impression cast used to create a second mold for a second false nail;
selecting a second unique design for the second false nail; and
paying for the false nail with the at least one unique design.
